(19) United States
(12) Patent Application Publication
(10) Pub. No.: US 2014/0246862 A1
(43) Pub. Date: Sep. 4, 2014

(54) AIRBORNE WIND ENERGY SYSTEM

(71) Applicant: CASE WESTERN RESERVE UNIVERSITY, Cleveland, OH (US)

(72) Inventors: Mario A. Garcia-Sanz, Moreland Hills, OH (US); Nicholas White, Shaker Heights, OH (US); Nicholas C. Tierno, Clifton, VA (US)

(21) Appl. No.: 14/348,447

(22) PCT Filed: Sep. 28, 2012
(86) PCT No.: PCT/US2012/058136

§ 371 Date: Mar. 28, 2014

Related U.S. Application Data
(60) Provisional application No. 61/540,329, filed on Sep. 28, 2011.

(51) Int. Cl. F03D 9/00

(52) U.S. Cl. CPC F03D 9/002
USPC 290/55

(57) ABSTRACT

An airborne wind energy system includes a lift system, a wind power generating system, a tether, and a control system. The lift system including a substantially airtight chamber for storing lighter-than-air gases. The wind power generating system is coupled to the lift system and including two rotating assemblies and a generator. The tether is coupled to the wind power generating system and tethers the airborne wind energy system to the ground. The two rotating assemblies are coupled to the generator and arranged to rotate in opposite directions so that the generator generates electrical power when the two rotating assemblies rotate in opposite directions.

### CROSS-REFERENCE TO RELATED APPLICATION

This application claims the full benefit of and priority to U.S. Provisional Patent Application Ser. No. 61/540,329, filed on Sep. 28, 2011, and entitled Airborne Wind Turbine, which is hereby incorporated by reference herein in its entirety.

### TECHNICAL FIELD

This disclosure generally relates to apparatuses and methods related to power generation systems for generating electricity from wind energy. More particularly, this disclosure relates to generating electrical power by deploying wind turbine systems at an elevated position above the surface of the earth.

### BACKGROUND

Airborne wind energy (AWE) systems are systems that are capable of deploying an electrical power generating assembly above the surface of the earth without the permanent infrastructure associated with conventional wind turbines. Because AWE systems can be arranged so that such systems do not rely on permanent infrastructure, AWE systems can provide electrical power to locations that are not served by conventional wind turbines. AWE systems can also provide electrical power to locations that cannot access an electrical grid and locations where the implementation of an electrical grid is impractical or cost prohibited.

Non-limiting example of locations and situations that can be served by AWE systems include: providing electrical power to ships and offshore drilling platforms; providing electrical power to remote, industrial locations that cannot access an electrical grid; providing electrical power to locations and operations that typically rely on diesel generators; providing electrical power to military encampments that necessitate rapid and unpredictable movements of personnel and equipment; providing electrical power to villages in the developing world that have no access or inconsistent access to electrical power; providing electrical power for micro-grids, etc. As will be understood, AWE systems can provide electrical power to locations that are served by conventional power generation systems and delivery systems as well as locations that are not served by such conventional systems.

For conventional wind energy systems, determining a proper location to deploy electrical power generating assemblies such as wind turbines can be challenging. For example, wind turbines are most efficient when positioned at a location where winds blow consistently and blow at a relatively high speed. Conventional wind turbine sites need to accommodate the infrastructure required to support the wind turbine and capital must be expended to build the infrastructure to support the wind turbine. Typically, conventional wind turbines are statically located on land-based sites and shallow offshore sites. Therefore, seasonal changes in wind consistency and wind speed can cause inefficiencies in such land-based systems. Wind turbines that can be positioned dynamically with regard to geography and altitude above the surface of the earth can offer greater energy generating efficiencies and possibilities than conventional land-based wind turbines.

### SUMMARY

In one embodiment, an airborne wind energy system includes a lift system, a wind power generating system, a tether, and a control system. The lift system includes a substantially airtight chamber for storing lighter-than-air gases. The wind power generating system is coupled to the lift system and including at least one rotating assembly. The tether is coupled to the wind power generating system.

In another embodiment, an airborne wind energy system includes a wind power generation system, which includes a first rotating assembly, a second rotating assembly, and a third rotating assembly. The second rotating assembly is arranged to rotate in a direction opposite of the first rotating assembly, and the third rotating assembly arranged to rotate in the same direction as the first rotating assembly.

In another embodiment, the airborne wind energy system includes a wind power generation system, which includes a first rotating assembly, a second rotating assembly, and a third rotating assembly. The net angular momentum of the first rotating assembly, the second rotating assembly, and third rotating assembly is substantially zero when the first rotating assembly, the second rotating assembly, and third rotating assembly are rotating and the respective magnitude of the angular velocities are substantially the same.

In another embodiment, the airborne wind energy system includes a wind power generation system, which includes a first rotating assembly, a second rotating assembly, and a third rotating assembly. Each of the first rotating assembly, the second rotating assembly, and third rotating assembly include at least one airfoil. The at least one airfoil of each of the first rotating assembly, the second rotating assembly, and third rotating assembly is adjustable by a control system.

In one embodiment of an airborne wind energy system, the lift system is an airship. The airship includes a body that houses a substantially airtight chamber. The airship also includes a first wing attached to the body, a second wing attached to the body, and a tail section attached to the body. The first wing can include a first aileron and the second wing can include a second aileron. The first aileron and second aileron are adjustable by a control system. The control system adjusts the first aileron and second aileron so that the airship maintains a static position.

### BRIEF DESCRIPTIONS OF DRAWINGS

It is believed that certain examples will be better understood from the following description taken in combination with the accompanying drawings in which:

FIG. 1 is a perspective view depicting an airborne wind energy system in accordance with one embodiment, where the airborne wind energy system includes an airship and a horizontal turbine assembly;

FIG. 2 is a perspective view depicting the turbine assembly of the airborne wind energy system of FIG. 1;

FIG. 3 is a perspective detailed view depicting a generator of the turbine assembly of FIG. 2;

FIG. 4 is a perspective view depicting another turbine assembly that can be used with airborne wind energy systems disclosed herein;

FIG. 5 is a perspective view depicting another turbine assembly that can be used with airborne wind energy systems disclosed herein;

FIG. 6 is a detailed view depicting a pitch control system that can be used with turbine assemblies disclosed herein;

FIG. 7 is a perspective view depicting another airborne wind energy system in accordance with one embodiment, wherein the airborne wind energy system includes an airship and a vertical turbine assembly;

FIG. 8 is a detailed view depicting a universal joint of the airborne wind energy system of FIG. 1;

FIG. 9 is a detailed view depicting a tether of the airborne wind energy system of FIG. 1;

FIG. 10 is a detailed view depicting the tether secured to the universal joint of the airborne wind energy system of FIG. 1;

FIG. 11 is a perspective view of a tether stand that can be use with of the airborne wind energy system of FIG. 1;

FIG. 12 is a detailed perspective view depicting the airship of the airborne wind energy system of FIG. 1;

FIG. 13 is perspective view of the airship of the airborne wind energy system of FIG. 1 identifying physical forces experienced by a deployed airship;

FIG. 14 is a perspective view depicting the airborne wind energy system of FIG. 1;

FIG. 15 is a perspective view depicting another airborne wind energy system in accordance with one embodiment, where the airborne wind energy system includes a lift system and a horizontal turbine assembly;

FIG. 16 is a perspective view depicting the lift system of the airborne wind energy system of FIG. 15;

FIG. 17 is a cross-sectional view depicting an envelope of the lift system of FIG. 16; and

FIG. 18 is a perspective view depicting another turbine assembly for use with airborne wind energy systems disclosed herein.

### DETAILED DESCRIPTION

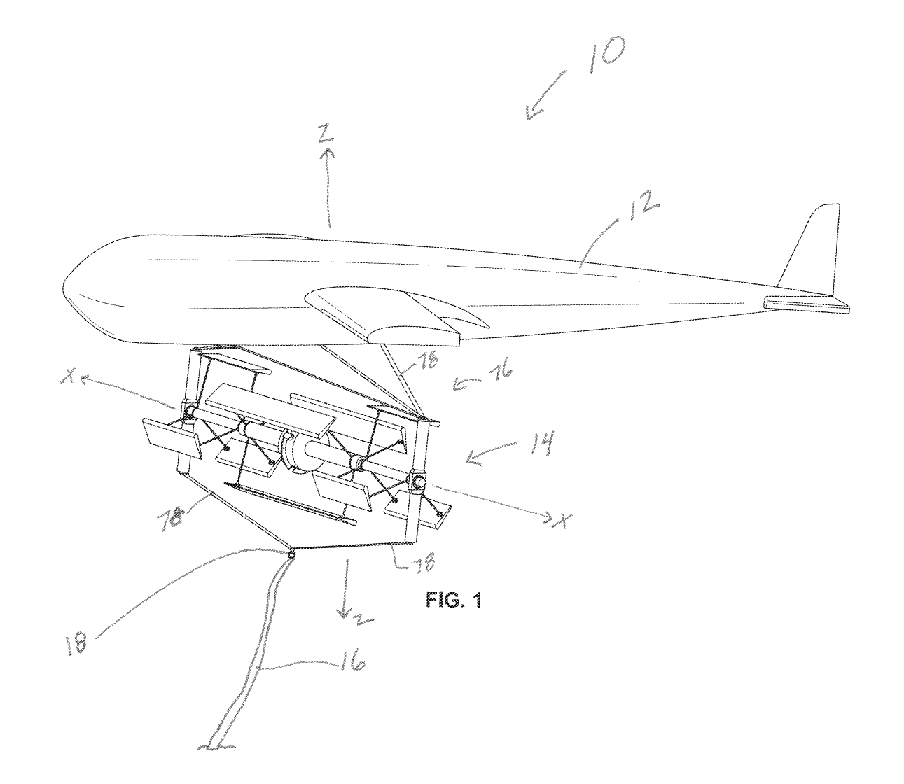

The apparatuses and methods disclosed in this document are described in detail by way of examples and with reference to the figures. It will be appreciated that modifications to disclosed and described examples, arrangements, configurations, components, elements, apparatuses, methods, etc. can be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Selected examples of airborne wind energy systems are hereinafter disclosed and described in detail with reference made to FIGS. 1-18.

AWE systems described and disclosed herein: can provide electrical power at a lower economic rate (i.e., cost per kilowatt-hour (kWh)) than conventional renewable energy systems; can provide higher electrical power production than conventional wind turbines; and can provide greater mobility than most energy collection systems (i.e., can be deployable to more sites than conventional energy collection systems and can be rapidly moved from one site to another), AWE systems described and disclosed herein include systems that can be deployed at various altitudes above the surface of the earth, including generally low altitudes in the range of approximately 50 to 300 meters as well as higher altitude ranges of approximately 2-3 kilometers.

In one example, an AWE system generally includes a lift system to elevate and position the AWE system above the surface of the earth, and an independent wind power generating system. An AWE system can be secured to the surface of the earth by, for example, a cable or tether. A tether can serve as both a structural element to secure the AWE system to the surface of the earth and as an electrical element to transmit electrical power to ground-based electrical components, power storage facilities, or grid collection facilities. In addition, the tether can be a communication system that provides information and instructions to control components of an AWE system and receives information and instructions from such control components. As will be further described, in one example a multi-input multi-output, robust, and nonlinear control system can coordinate and control the lift, positioning, and flight of an AWE system and can coordinate and control the generating, gathering, storing, and using of electrical power provided by an AWE system. In one example, the lift system can be a lighter-than-air low-drag airship. Such an airship can include aerodynamic wings and control surfaces to provide longitudinal, lateral, and altitudinal control of the AWE system. In one example, the wind power generating system can be one or more wind turbines that are variable-speed, aerodynamic rotor systems with a counter-rotating direct-drive synchronous generator.

An example of an AWE system 10 is illustrated in FIG. 1. The AWE system 10 includes an airship 12 that functions as a lift system to lift and position the AWE system 10 above the surface of the earth. The AWE system 10 also includes a turbine assembly 14 that functions as a wind generation system and is coupled to the airship 12. Although the airship 12 and turbine assembly 14 are coupled, it will be understood that the airship 12 and turbine assembly 14 can function independent of each other. That is to say, the airship 12 illustrated in FIG. 1 can be used with any number of wind generation systems. Likewise, the turbine assembly 14 illustrated in FIG. 1 can be used with any number of lift systems.

The AWE system 10 also includes a tether 16 coupled to the turbine assembly 14. As will be subsequently described, the tether 16 can be coupled to the turbine assembly 14 on a first end and secured to the surface of the earth on a second end, thus tethering the AWE system to the surface of the earth. Such an arrangement can allow for the AWE system 10 to be positioned at an altitude above the surface of the earth, while remaining secured to the surface of the earth. The tether 16 can be coupled to the turbine assembly 14 using a universal joint 18. The tether 16 can have a composite structure that includes one or more structural elements that can withstand the forces associated with tethering the AWE system 10 and one or more electrical and/or communication elements for transmitting electrical power, information, instructions, and data between the AWE system 10 and ground-based systems.

As will be further described, the AWE system 10 can be lifted to a desirable altitude and lateral and longitudinal position above the surface of the earth by the airship 12 and remain aloft for extended periods of time. The altitude at which the AWE system 10 is positions can be a beneficial location for wind energy generation because of favorable wind speeds and consistency. The turbine assembly 14 can be arranged so that while deployed for the extended period of time the turbine assembly 14 can generate electrical power energy because of movement of components of the turbine assembly 14 caused by wind currents engaging the turbine assembly 14.

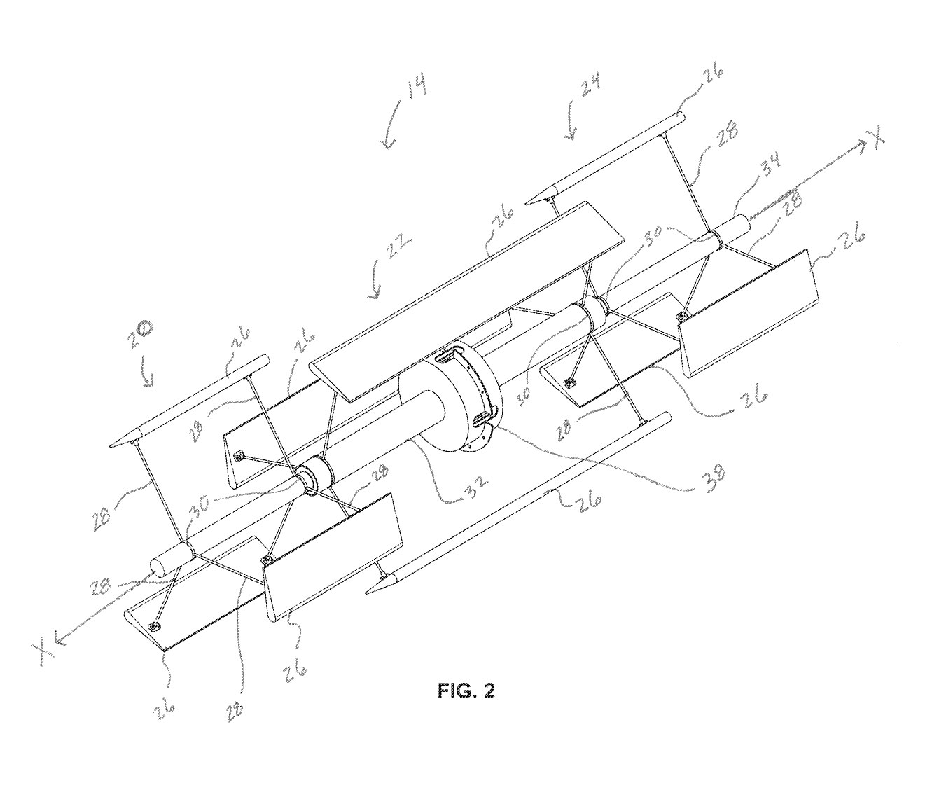

As illustrated in FIG. 2, one example of a turbine assembly 14 can include three rotating assemblies 20, 22, 24. As will be further described herein, a turbine assembly can include any number of rotating assemblies. In the example illustrated in FIG. 2, each rotating assembly 20, 22, 24 includes three blades or airfoils 26, which are mechanically connected together by a series of connector rods 28 and ring couplers 30. The turbine assembly 14 can further include an outer shaft 32 and an inner shaft 34. The outer shaft 32 can be arranged so that the inner shaft 34 can fit within the outer shaft 32 and both shafts 32, 34 can rotate about a common axis X. The ring couplers 30 can be secured to the outer and inner shafts 32, 24. Such an arrangement provides for the rotating assemblies 20, 22, 24 to also rotate about the common axis X.

The arrangement and orientation of the airfoils 26 can determine in which rotational direction a rotating assembly 20, 22, 24 rotates. For example, the airfoils 26 on the two outer rotating assemblies 20, 24 are arranged and oriented so that those rotating assemblies 20, 24 rotate in a first direction. Whereas, the airfoils 26 of the inner rotating assembly 22 are arranged and oriented so that rotating assembly 22 rotates in a second and opposite direction as compared to the two outer rotating assemblies 20, 24. Such an arrangement can be referred to as counter-rotating turbine assemblies. It will be understood that although the rotating assemblies 20, 22, 24 are each illustrated and described as having three airfoils 26, a rotating assembly can include more than three airfoils or less than three airfoils.

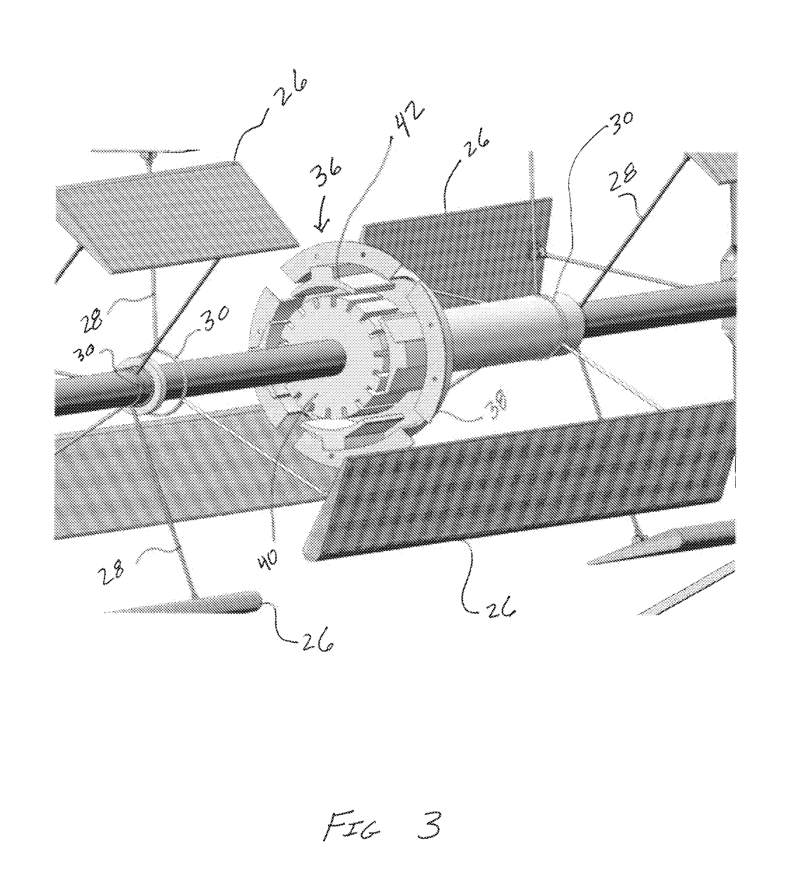

As illustrated in FIG. 3, the turbine assembly 14 can include a generator 36 located within a housing 38. The generator 36 can include a rotor 40 and a stator 42. The rotor 40 can be secured to the inner shaft 34, and the stator 42 can be secured to the outer shaft 32. As will be understood, the generator 36 can be arranged to generate electrical power when the rotor 40 and stator 42 experience relative rotational movement. The amount of electrical power generated by the generator 36 can be directly related to the angular velocity of the relative rotational movement of the rotor 40 and stator 42. Because of the arrangement shown in FIG. 3, the rotor 40 rotates as the inner shaft 34 rotates, and the stator 42 rotates as the outer shaft 32 rotates. The rotor 40 and the stator 42 can be arranged so that they are magnetically linked.

The airfoils 26 can be arranged so that when wind currents apply a force to the airfoils 26, the rotating assemblies 20, 22, 24 rotate or spin in a circular path about the common axis X. Because the rotating assemblies 20, 22, 24 are secured to the outer and inner shafts 32, 34 by the coupling rings 30, the rotation of the rotating assemblies 20, 22, 24 will also rotate the outer and inner shafts 32, 34. Because the outer shaft 32 is secured to the stator 42 and the inner shaft 34 is secured to the rotor 40, the rotation of the rotating assemblies 20, 22, 24 can cause relative rotational movement of the rotor 40 and stator 42. Such relative rotational movement causes the generator 36 to generate electrical power. The arrangement as shown in FIG. 3 results in opposite rotational movements of the rotor 40 and the stator 42. Because the rotor 40 and stator 42 rotate in opposite directions, the angular velocity of the generator 36 is effectively doubled as compared to a generator where the rotor rotates and the stator is static. Because the angular velocity of the generator 36 effectively doubles, the generator 36 generates substantially more energy and is substantially more efficient than a generator with a static stator. Because of the efficiency of the generator 36, the components that comprise the generator 36 can be smaller and weigh substantially less than generators with a static stator. Such reductions in size and weight of components can result in AWE systems that are smaller and/or lighter in weight and, thus, easier to deploy at an altitude above the surface of the earth. As will be understood, the generator 36 can be a direct-drive synchronous generator.

Arranging a turbine assembly so that some rotating assemblies rotate in one direction and other rotating assemblies rotate in an opposite direction can result in an AWE system that flies smoothly and is controllable when statically positioned. Such an arrangement also results in a generator that efficiently produces electrical power. Such an arrangement that provides a combination of masses, distances and angular velocities that result in zero angular momentum can also reduce or substantially eliminate any net torque on the AWE system due to the rotation of rotating assemblies of the turbine assembly. The reduction or substantial elimination of torque can be accomplished by balancing the angular momentum produced by the rotating assemblies such that the net angular momentum for the turbine assembly is approximately zero. According to the law of conservation of angular momentum, when no external torque acts on the AWE system, no change of angular momentum will occur.

For the turbine assembly 14 as shown for example in FIG. 2, the angular momentum (L) produced by each rotating assembly 20, 22, 24 is equal to the product of the inertia (I) of the rotating assemblies 20, 22, 24 and the rotating assemblies' 20, 22, 24 angular velocity (represented by the Greek letter omega (ω)). For each rotating assembly 20, 22, 24, the inertia is approximately the sum of the product of the mass (m) of each airfoil 26 and the square of the distance (r) that the airfoils 26 is positioned from the axis of rotation X.

Assuming a number (n1) of airfoils with mass (m₁ᵢ) and distance (r₁ᵢ) from the axis of rotation X, varying i from 1 to n1, for the first single rotating assembly; a number (n2) of airfoils with mass (m₂ⱼ) and distance (r₂ⱼ) from the axis of rotation X, varying j from 1 to n2, for the second single rotating assembly; and in general a number (nf) of airfoils with mass (m_{fk}) and distance (r_{fk}) from the axis of rotation X, varying k from 1 to nf, for the f-th single rotating assembly of the turbine assembly (see as an example FIG. 2 for airfoils 26 of single rotating assemblies 20, 22, 24, with n1=3, n2=3, n3=3), the equations for determining the angular momentum of a single rotating assembly are provided below. Equation 1 is the inertia (Iₖ) for the k single rotating assembly of t airfoils, and Equation 2 is its angular momentum while rotating at an angular velocity ωₖ.

Iₖ=mₖ₁rₖ₁²+mₖ₂rₖ₂²+mₖ₃rₖ₃²+ . . . +Mₖₜrₖₜ² Equation 1:

where t is the number of airfoils of the single rotating assembly k

LₖIₖωₖ Equation 2:

It will be understood that the sum of the angular momentums of all the rotating assemblies of a turbine assembly is the net angular momentum of the turbine assembly. A turbine assembly can be arranged so that its net angular momentum is substantially zero when no external torque acts on the AWE System, according to the law of conservation of angular momentum. As previously described for the example illustrated in FIG. 2, two outer rotating assemblies 20, 24 rotate in a first direction and one inner rotating assembly 22 rotates in a second and opposite direction. The airfoils 26 of the single inner rotating assembly 22 as shown in FIG. 2 are substantially larger (i.e., have a larger mass) than the airfoils 26 of the two outer rotating assemblies 20, 24. In addition, it will be understood that because the two outer rotating assemblies 20, 24 rotate in a direction opposite the rotation of the one inner rotating assembly 22, the angular velocity (ω) of the two outer rotating assemblies 20, 24 will be of an opposite sign as compared to the angular velocity (−ω) of the one inner rotating assembly 22. Therefore, the angular momentum of the one inner rotating assembly 22 will be substantially larger and of a different sign as the angular momentum of either of the two outer rotating assemblies 20, 24.

Using Equation 1 and Equation 2, the following equations are applicable to the turbine assembly 14 shown in FIG. 2, provided the following assumptions: 1) the mass of airfoils 26 of the two outer rotating assemblies 20, 24 is m; 2) mass of airfoils 26 of the one inner rotating assembly 22 is 2 m; 3) all airfoils 26 are positioned a distance r from the axis of rotation X; 4) the two outer rotating assemblies 20, 24 and the one inner rotating assembly 22 rotate in opposite directions; and 5) the magnitude of the angular velocity of the two outer rotating assemblies 20, 24 is approximately equal to the angular velocity of the one inner rotating assembly 22. Equation 3 is the inertia (I₁) of an inner rotating assembly 22. Equation 4 is the inertia (I₂) of an outer rotating assembly 20, 24. Equation 5 is the net angular momentum (L) of the turbine assembly 14.

I₁=2mr²+2mr²+2mr²=6mr² Equation 3:

I₂=mr²+mr²+mr²=3mr² Equation 4:

L=I₁(−ω)+2I₂ω=−6mr²ω+2(3mr²ω)=−6mr²ω+6mr²ω=0 Equation 3:

As will be understood, turbine assemblies can be arranged with any number of rotating assemblies so that the angular momentum of the turbine assembly is substantially zero, which will substantially eliminate any torque on the AWE system due to the rotation of the rotating assemblies. For example, turbine assemblies can be designed and arranged to have substantially zero angular momentum by varying the number, geometry, size, weight, and position of airfoils; governing the angular velocity of rotational assemblies; and controlling the direction of rotation of rotating assemblies.

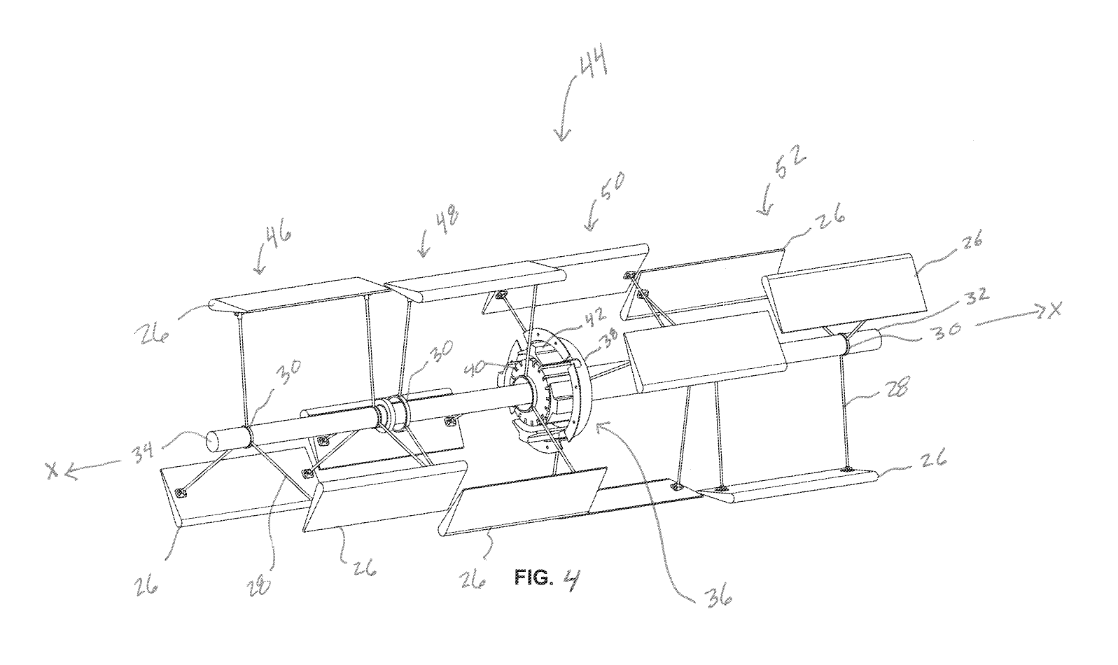

Another example of a turbine assembly 44 is illustrated in FIG. 4. The turbine assembly 44 includes four rotating assemblies 46, 48, 50, 52. Similar to the turbine assembly 14 illustrated in FIG. 2, each rotating assembly 46, 48, 50, 52 includes three airfoils 26 that are joined together by connector rods 28 and ring couplers 30. The turbine assembly 44 includes a generator 36 with a rotor 40 and a stator 42 in a housing 38. The two outer rotating assemblies 46, 52 are arranged to rotate in a first direction and are secured to an outer shaft 32 (a portion of the outer shaft 32 and housing 48 are removed to review the rotor 40 and stator 42). The two inner rotating assemblies 48, 50 are arranged to rotate in a second and opposite direction and are secured to an inner shaft 32. It will be understood that when wind currents cause the rotating assemblies 46, 48, 50, 52 to rotate, the rotor 40 and stator 42 will rotate in opposite directions and the generator 36 can efficiently generate electrical power. It will also be understood that the airfoils 26 and the rotating assemblies 46, 48, 50, 52 generally can be arranged so that the angular momentum of the turbine assembly 44 is substantially zero. In one example, the turbine assembly 44 can produce a substantially zero angular momentum by arranging all the airfoils 26 of the rotating assembly 44 to have substantially the same mass and be positioned substantially the same distance from the axis of rotation X.

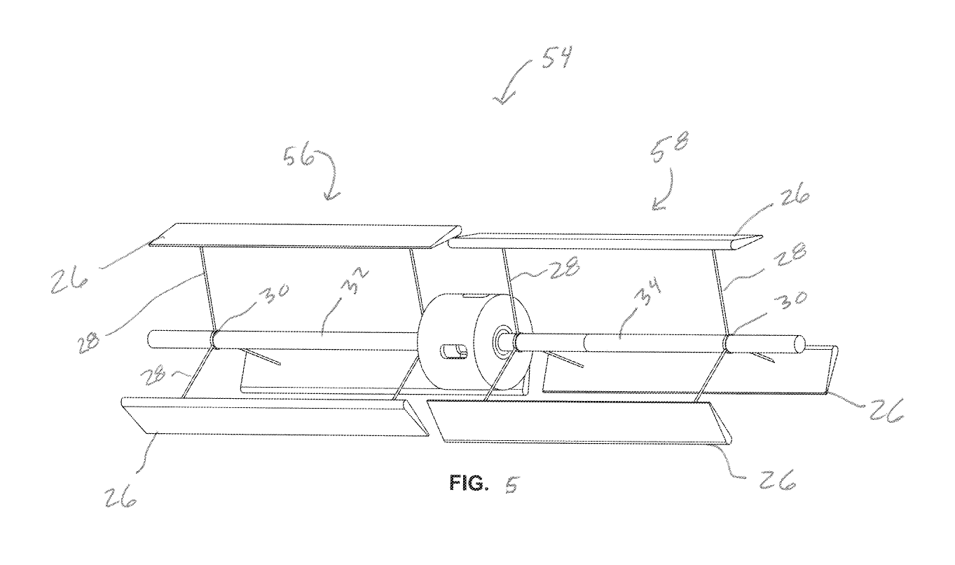

Another example of a turbine assembly 54 is illustrated in FIG. 5. The turbine assembly 54 includes two rotating assemblies 56, 58. Similar to the turbine assemblies 14, 44 illustrated in FIGS. 2 and 4, each rotating assembly 56, 58 includes three airfoils 26 that are joined together by connector rods 28 and ring couplers 30. The turbine assembly 54 includes a generator 36 with a rotor 40 and a stator 42 in a housing 38. A first rotating assembly 56 is arranged to rotate in a first direction and are secured to an outer shaft 32. A second rotating assembly 58 is arranged to rotate in a second and opposite direction and are secured to an inner shaft 32. It will be understood that when wind currents cause the rotating assemblies 56, 58 to rotate, the rotor 40 and stator 42 will rotate in opposite directions and the generator 36 can efficiently generate electrical power. It will also be understood that the airfoils 26 and the rotating assemblies 56, 58 generally can be arranged so that the angular momentum of the turbine assembly 54 is substantially zero. In one example, the turbine assembly 54 can produce a substantially zero angular momentum by arranging all the airfoils 26 of the turbine assembly 54 to have substantially the same mass and be positioned substantially the same distance from the axis of rotation X.

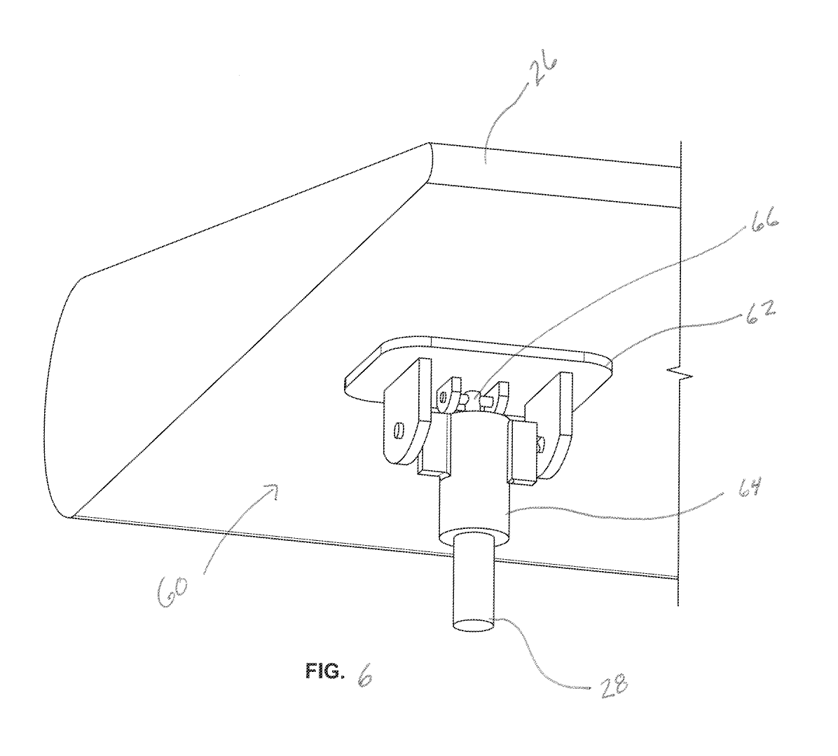

FIG. 6 illustrates a detailed view of a method for connecting a connector rod 28 to an airfoil 26. Each connector rod 28 is coupled to the airfoil 26 by a pitch control assembly 60. The pitch control assembly 60 includes a bracket 62, a coupling 64, and a control motor housed within the coupling 64. The bracket 62 is secured to the airfoil 26 and the coupling 64 is arranged to secure the connector rod 28 to the bracket 64, and thus, secure the connector rod 28 to the airfoil 26. The control motor can be arranged as a linear motor and can include a piston 66 that is eccentrically and rotatably coupled to the bracket 62. The AWE system 10 can include a control system that controls the movement of the piston 66 of the control motor. As will be understood, extending or retracting the piston 66 of the control motor with respect to the coupling 64 can cause the airfoil 26 to pivot or rotate. Such pivoting or rotating can position the airfoil 26 with respect to the wind current.

Each connector rod 28 of the turbine assembly 14 can be secured to an airfoil 26 by a pitch control assembly 60, and each pitch control assembly 60 can be arranged such that each airfoil can be adjusted independently using the method described herein. The AWE system 10 can include sensors that can sense environmental conditions around the AWE system 10, such as wind speed, wind direction, wind consistency, and the like. Such sensors can be electronically coupled to the control system. The control system can evaluate the information provided by the sensors and drive the piston 66 so as to position the airfoils 26 at advantage angles with respect to the wind current to increase the efficiency of turbine assemblies 14. Such adjustments can improve the positioning of the AWE system and the efficiency of electrical energy gathering.

In another example, each airfoil 26 can by individually and dynamically adjusted and positioned as the rotating assemblies 20, 22, 24 rotate due to the wind current. As will be understood, the airfoil 26 can experience different forces from the wind current depending on where the airfoil 26 is in the rotational cycle. The angle of the airfoils 26 can be dynamically adjusted as the airfoil 26 proceeds through the full 360 degree rotation to provide for a smoother and consistent rotational path for the rotating assemblies 20, 22, 24.

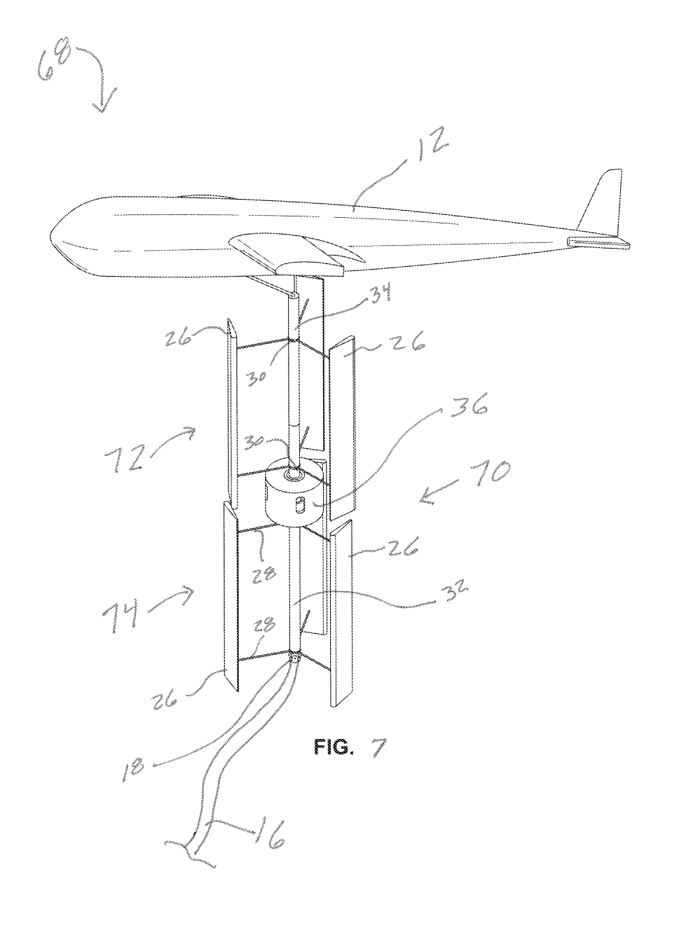

Another example of an AWE system 68 is illustrated in FIG. 7. As shown, the turbine assembly 70 can be oriented vertically with respect to the airship 12. A tether 16 can be coupled to the turbine assembly 70 by a universal joint 18. Similar to the turbine assembly 54 illustrated in FIG. 5, the turbine assembly 70 includes two rotating assemblies 72, 74. The turbine assembly 70 includes a generator 36. Each rotating assembly 72, 74 includes airfoils 26 joined together by connector rods 28 and coupler rings 30. The rotating assemblies 72, 74 can be arranged to rotate in opposite directions. The upper rotating assembly 72 can be secured to an inner shaft 34, and the lower rotating assembly 74 can be secured to an outer shaft 32. Such an arrangement provides for the ability to increase the effective angular speed of the generator 36 as well as reduce the net angular momentum. Positioning the turbine assembly 70 vertically can provide for efficient collection of electrical energy because regardless of the orientation of the AWE system 68, the rotating assemblies 72, 74 can fully engage wind currents.

As illustrated in FIG. 1, a harness assembly 76 can be provided to join the airship 12, turbine assembly 14, and the tether 16. The harness assembly 76 can include a plurality of connecting bars 78. As is shown, the plurality of connecting bars 78 can provide structural support for securing the turbine assembly 14 to the airship 12 and the tether 16 to the turbine assembly 14. The connector bars 78 of the harness assembly 76 can be fabricated from high-strength, low-weight materials. The harness assembly 76 can secure the turbine assembly 14 to the airship 12 using a universal joint similar to the universal joint 18 that secures the tether 16 to the turbine assembly 14. When an airship and a turbine assembly are coupled by a universal joint, the turbine assembly can be arranged to self-orient with respect to the wind current. Such self-orientation can be facilitated by the addition of one or more vanes to the turbine assembly so that when the vanes engage with the wind current the turbine assembly is positioned so that the wind current engages the airfoils efficiently. Such an arrangement provides for both the airship and the turbine assembly to independently control its orientation with respect to the direction of the wind current.

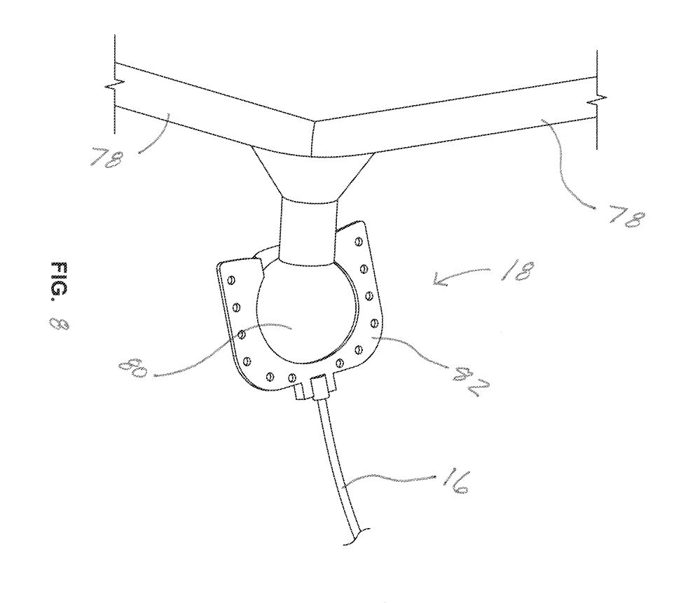

As previously discussed, the tether 16 can be coupled to a universal joint 18. FIG. 8 illustrates a detailed view of the universal joint 18. The universal joint includes a ball 80 and a pair of joint connectors 82 that can form a socket. Only one joint connector 82 is illustrated in FIG. 6. The second joint connector is removed so that the operation of the universal joint 18 can be appreciated. The ball 80 can either be an integral part of the harness assembly 76 or be attached to the harness assembly 76. The tether 16 can be connected to the universal joint 30. The two joint connectors 82 can either be bolted together or secured in another manner. The universal joint 18 restricts translational movement but allows three degrees of rotational freedom. Such an arrangement provides for freedom of the movement of the rotating assembly 14 and the airship 12 with respect to the tether 16. The arrangement can also reduce the stresses and strains applied to the tether 16 as the rotating assembly 14 and airship 12 move with respect to the tether 16.

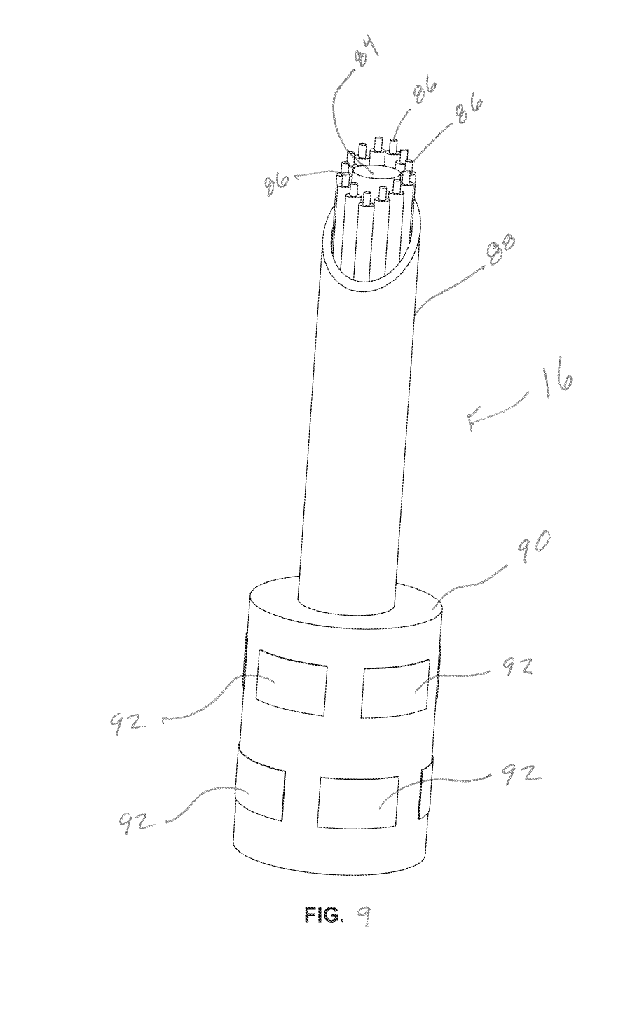

The electrical energy generated by the turbine assembly 14 can be transferred to a ground station through, for example, an attached tether 16. The tether 16 can be a composite structure that serves a number of functions for the AWE system 10. One example of the composite structure of the tether 16 is illustrated in FIG. 9. The tether 16 can both secure the AWE system 10 to the surface of the earth and function as a conduit for electrical components such as wires that connect the AWE system 10 and ground-based components and systems. In one example the tether 16 includes an internal cable 84 that can provide structural integrity for bearing the forces, such as tensile forces, experienced by the tether 16. The tether 16 also includes a plurality of wires 86 arranged to transmit electrical power or signals such as command signals or data between the AWE system 10 and ground-based components and systems. In one example, multiple wires 86 can be utilized to transmit electrical power to ground-based systems. The tether 16 can further includes a sheath 88 enclosing the cable 84 and plurality of wires 86. The material of the sheath 88 can be a light-weight, flexible and resilient material. In one example, the sheath 88 is constructed of Kevlar. The sheath 88 can further be arranged to function as a load bearing structure that provides additional structural integrity for bearing forces applied to the tether 16. In one example, the tether 16 includes a bundle of braided aluminum strands that provides both structure integrity and electrical conductivity along the tether 16.

In one example, the tether 16 can be connected to the universal joint 18 through the use of a plug 90. The plug 90 can be secured to the universal joint 18 in any number of methods such as, for example, the plug can be screwed into the universal joint 18 or secured to the universal joint 18 using bolts. The plug 90 can include a plurality of plug electrode pads 92 that are in electrical communication with the wires 86.

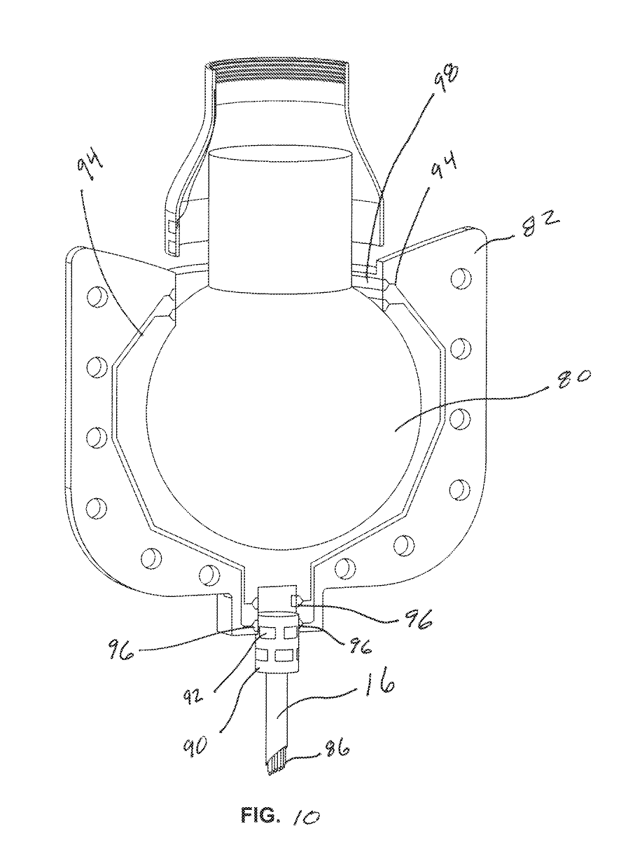

A method for electrically connecting the wires 86 of the tether 16 to elements of the AWE system 10 is illustrated in FIG. 10. Electrical communications, in one example, are provided for by traces 94 that are positioned within the universal joint 18. The traces 94 are connected on a first end to an elongated electrode pad 96 on the universal joint 18. The traces 94 can be connected on a second end to a circumferential electrode pad 98. The circumferential electrode pad 98 can be in electrical communication with components of the AWE system 10 such as the generator 36 or a control system that controls lift and stabilizing operations for the AWE system 10. It will be understood that the AWE system 10 can include additional traces or wires that electronically connect the circumferential electrode pads 98 to components of the AWE system 10.

The plug 90 can be positioned within the universal joint 18 so that the plug electrode pads 92 align with the elongated electrical pads 96 on the universal joint 18 and create an electrical connection. As is shown in FIG. 10, the universal joint 18 can include a port that accommodates the plug 90. The plug 90 can have an outer diameter that is substantially the same size as the inner diameter of the port of the universal joint 18. The plug 90 can be secured in the port so that the universal joint 18 cannot rotate with respect to the plug 90. However, a universal joint 18 can rotate freely with respect to the remainder of the AWE system 10. The circumferential electrode pads 98 are arranged such that electrical communication can be maintained while the universal joint 18 rotates freely. Therefore, electrical communication can be maintained between components of the AWE system 10 and the wires 86 of the tether 16 during the operation of the AWE system 10.

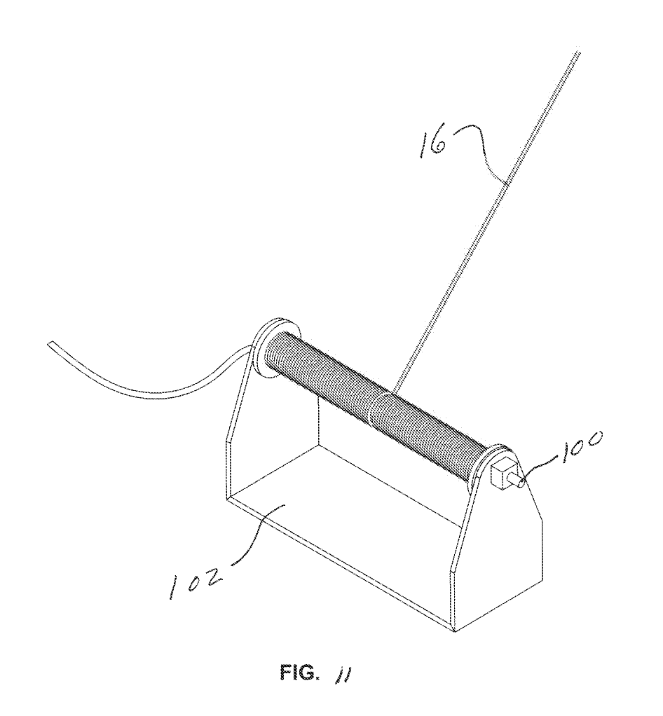

FIG. 11 illustrates a method for securing the AWE system 10 to the ground and a method for controlling the length of the tether 16 (i.e., and controlling the altitude of the AWE system 10). The tether 16 can be wound around a spindle 100 that is free to rotate in a tether stand 102. A small constant torque can be applied about the spindle 100 to retract the tether 16. This can reel-in slack in the tether 16 to prevent tangling, but the small constant torque can be arranged so that it is not sufficient in magnitude to reel in the AWE system 10. However, a tether motor (not shown) is capable of applying a required torque at a sufficient rate to both extend and retract the tether 16. The AWE system 10 can be reeled in for a number of reasons, including maintenance, inclement weather, and the like. The tether 16 can extend past the spindle 100 and tether stand 102 and be connected to ground-based components and systems so that electrical power can be transferred from the generator 36 to such ground-based components and systems and commands, information, and data can be exchanged between the AWE system 10 and such ground-based components and systems.

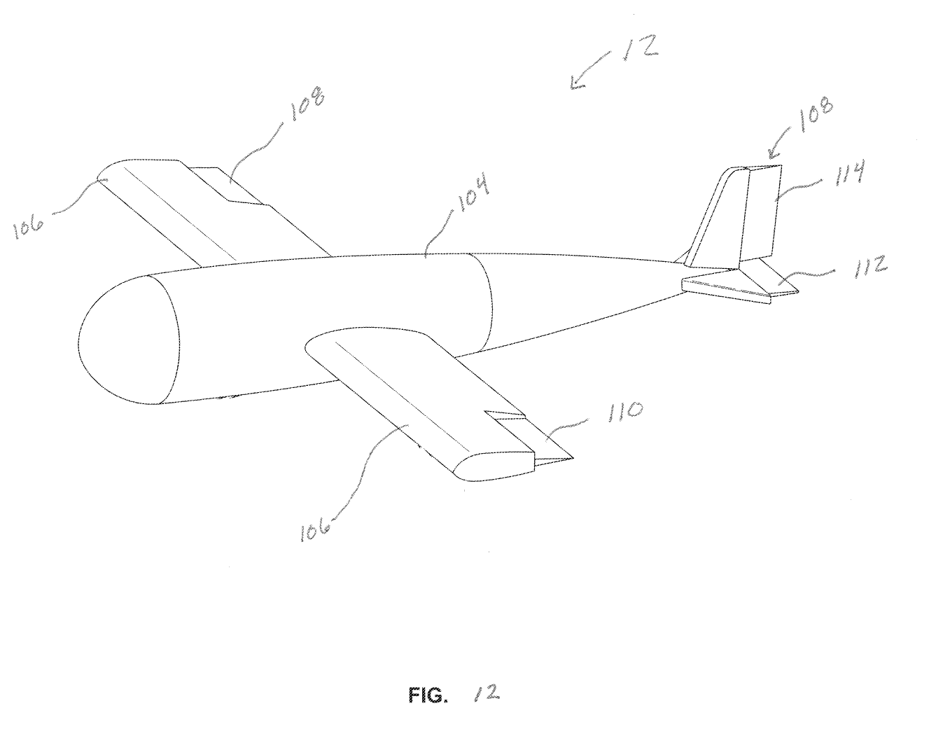

A detailed view of the airship 12 is illustrated in FIG. 12. The airship 12 is arranged so that it can provide a sufficient lift force to elevate the AWE system 10 to a desired altitude above the surface of the earth. The airship 12 is also arranged to provide for maintaining the AWE system 10 at a generally static and stable location once the AWE system 10 reaches is desired altitude. The airship 12 includes a generally low-drag body 104, a pair of aerodynamic wings 106, and a tail section 108. The low-drag body 104 provides for stability of the AWE system 10 because wind currents generally have lesser effects on a low-drag body 104 as compared to other structures. The airship 102 can be configured to be a lighter-than-air vessel, where the body 104 can be arranged to hold gases that are lighter-than-air. For example, the body 104 can be arranged to hold gases such as helium or hydrogen to provide a lift force to lift the airship 12 to a desired altitude. The body 104 and the gas held in the body 104 can be arranged so that the AWE system 10 achieves neutral buoyancy. That is to say that the lift force provided by the lighter-than-air gas in the body 104 of the airship 12 equals the gravitational forces applied on the AWE system 10 due to the collective weight of the components of the AWE system 10.

The wings 106 can provide aerodynamic surfaces to support the lift force and also provide stability for the AWE system 10. The tail section 108 can provide for alignment of the AWE system 10 relative to the wind current. The airship 12 can include a number of additional features that provide for controlling the three-dimensional positioning of the AWE system 10 in free space. For example, the wings 106 can include ailerons 110 and the tail section 108 can include elevators 112 and a rudder 114. The wings 106, tail section 108, ailerons 110, elevators 112, rudder 114 and the body 104 itself all provide controllable aerodynamic surfaces that, along with tensile forces that can be applied by the tether 16, can control the position and altitude of the AWE system 10 (i.e., six degrees of freedom) in free space. The AWE system can include a multi-input multi-output nonlinear control system to coordinate the movement or arrangement of various controllable aerodynamic surfaces so that the lift, positioning, and flight of the AWE system 10 is controlled.

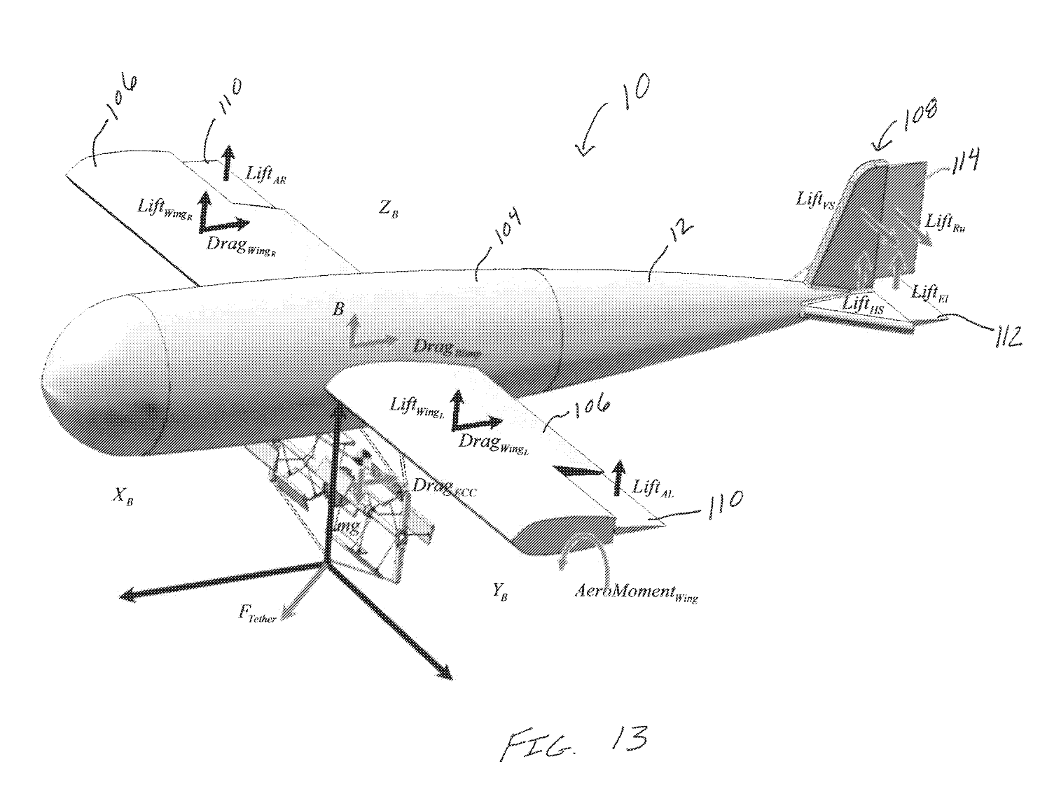

Such a control system can include a number of sensors to sense altitudinal position, longitudinal position, latitudinal position, wind speed, lift forces, drag forces, and the like. The control system can also be in electronic and/or mechanical communication with components such as ailerons 110, elevators 112, and rudder 114 to move or position such components as required to maintain a desired position or move to a new desired position. The wings 106 can also be arranged to pivot or rotate to assist in statically maintaining the AWE system 10 in a desired position. In one example, the control system can determine that the speed of the wind current is increasing. If no adjustments are made, the AWE system 10 could begin to drift backwards because the increased speed of the wind currents can causing increased drag on the AWE system 10. Because the AWE system 10 is tethered to the ground, the AWE system 10 could also lose altitude if it drifts backwards because the AWE system 10 will pivot about the point at which the AWE system 10 is secured to the ground by the tether 16. The control system can compensate for the increased drag due to increased wind speed by adjusting the ailerons 110 and/or elevators 112 to further engage the wind current and add to the existing lift force. The control system can also adjust the angle of the wings 106 to create more lift force. FIG. 13 illustrates forces applicable on the AWE system 10.

It will be understood that through such techniques the control system can balance forces such as the drag force, tether tensile force, and lift force to result in the AWE system 10 remaining generally statically positioned over long operational time periods. It will be understood that the AWE system can be positioned at a relatively small angle to the vertical line when the wind speed increases to create the proper balance of forces to keep the AWE system 10 generally statically positioned. In another example, the control system is located on the ground and the control system controls a plurality of AWE systems deployed adjacent to each other. The control system can be arranged such that it can communicate with each AWE system through a tether. The control system can continuously monitor and adjust, if necessary, the positions of the plurality of AWE systems to reduce or eliminate the possibility that adjacent AWE systems will interfere with each other. Such arrangements can provide for efficient generation of electrical power without unnecessarily occupying airspace.

It will be further understood that such control techniques can result in the AWE system 10 occupying a relatively small operational three-dimensional volume during deployment, even when wind speeds are variable over the duration of the deployment. Such control techniques provide for a plurality of AWE systems 10 to be deployed relatively close to each other because such control techniques can substantially reduce or eliminate the concern of AWE systems 10 interfering with the operation of adjacent AWE systems.

The ability to maintain the position of the AWE system 10 can improve the efficiency of energy generation of the turbine assembly 14. For example, the AWE system 10 can be deployed at an altitude where the wind current maintains a more consistent and higher speed than wind currents near the surface of the earth. Such conditions can result in more efficient energy generation than land-based turbines. Such higher and more consistent wind speeds can allow for smaller components and higher rotational speeds.

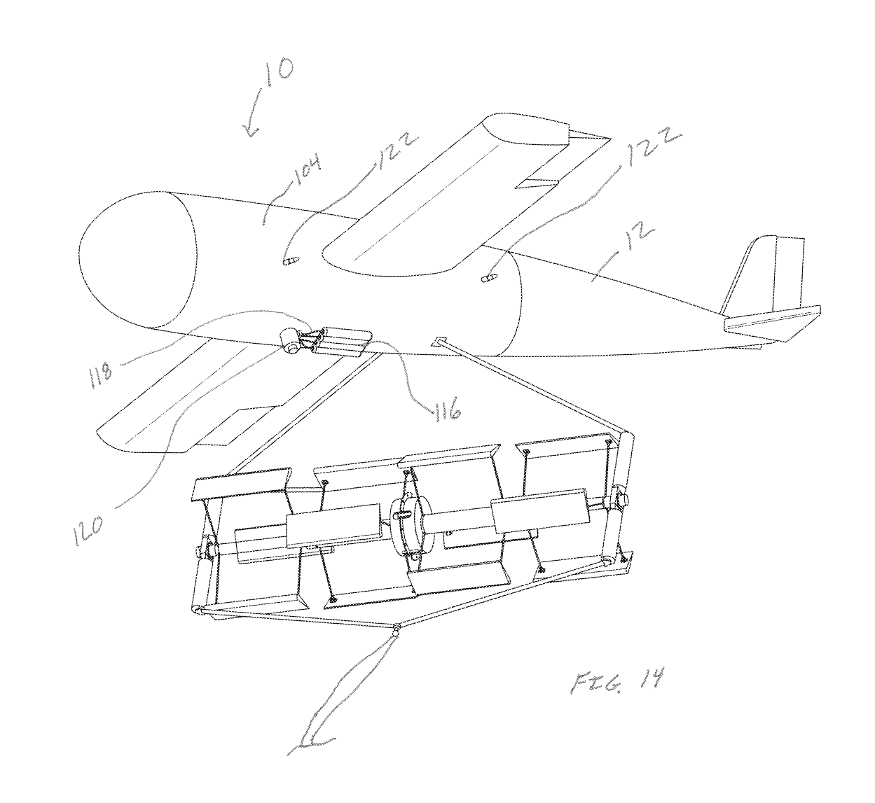

FIG. 14 illustrates the underside of the airship 12. The body 104 can be constructed of a light weight, resilient, and flexible material. The body 104 can be constructed so that it is substantially airtight and will not allow for substantial leakage of gases out of the body 104. However, there are circumstances where it is desirable to change the amount of gas in the body 104 by adding gas or removing gas. A series of gas canisters 116 can be secured to the body 104 of the airship 12. High pressure lines 118 can provide a fluid path from the canisters 116 through a manifold 120 and into the body 104 of the airship 12. In addition, a series of valves 122 can be positioned in the side of the body 104. A pump or motor system can be used to pump gas from the canisters 116 through the high pressure lines 118 and manifold 120 and into the body 104. It will be understood that it may be desirable to add gas to the body 104 to increase the lift force. Gas can also be removed or bled off through the valves 122 in the body 104. It will be understood that it may be desirable to reduce the amount of gas in the body 104 to decrease the lift force. The valves 122 can also be used to control the position or movement of the AWE system 10. For example, gas can be quickly released from a valve 122, which can serve as a source of propulsion to quickly move the AWE system 10.

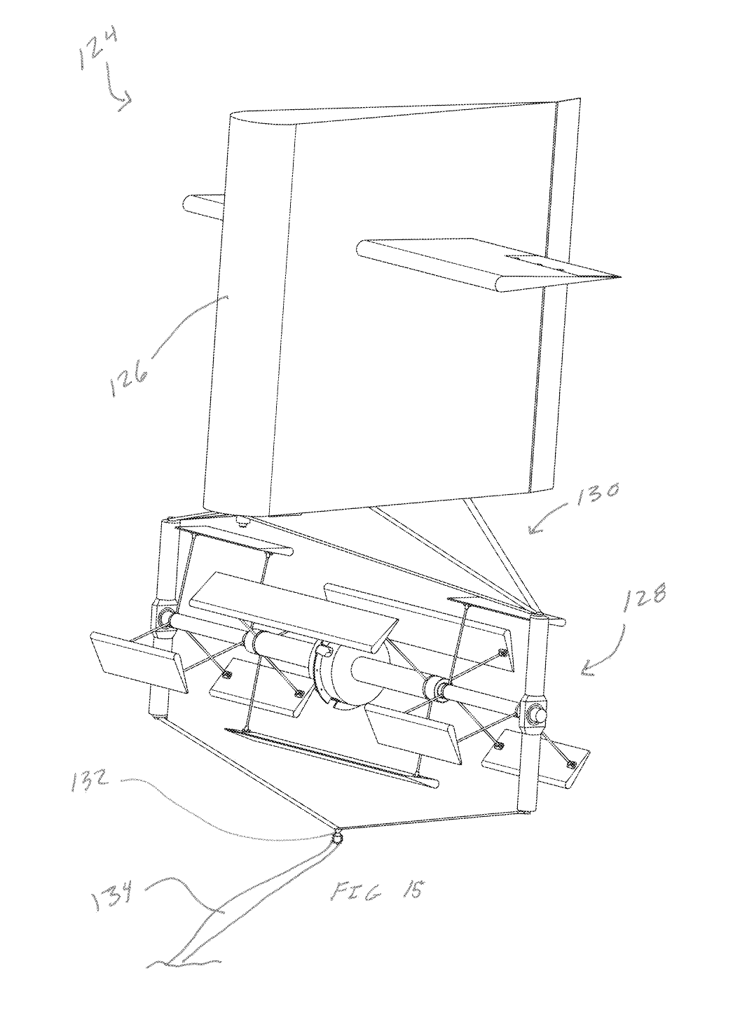

Another example of an AWE system 124 is illustrated in FIG. 15. The AWE system 124 includes a lift system 126 and a turbine assembly 128. Similar to the turbine assemblies previously described, the turbine assembly 128 includes rotating assemblies that rotated in opposite directions and a generator that is driven by the rotating assemblies and generates electrical power. The turbine assembly 128 can be attached to the lift system 126 by a cradle assembly 130. The cradle assembly 130 can be a series of connectors rigidly secured together. A universal joint 132 can attach the cradle 130 to a tether 134. The tether 134 can extend to a ground station, and can be arranged to transmitting electrical energy generated by the turbine assembly 128 to the ground. In addition, the tether 134 can be arranged to transmit information between the AWE system 124 and ground-based facilities.

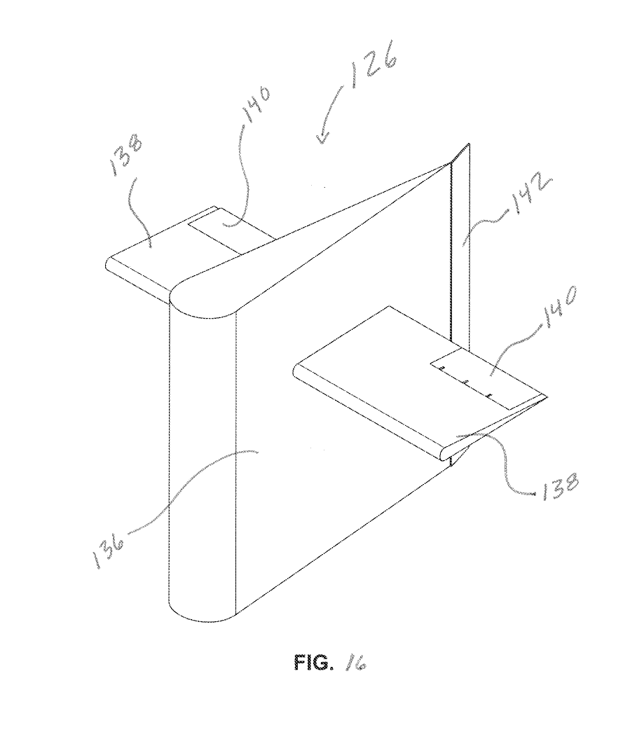

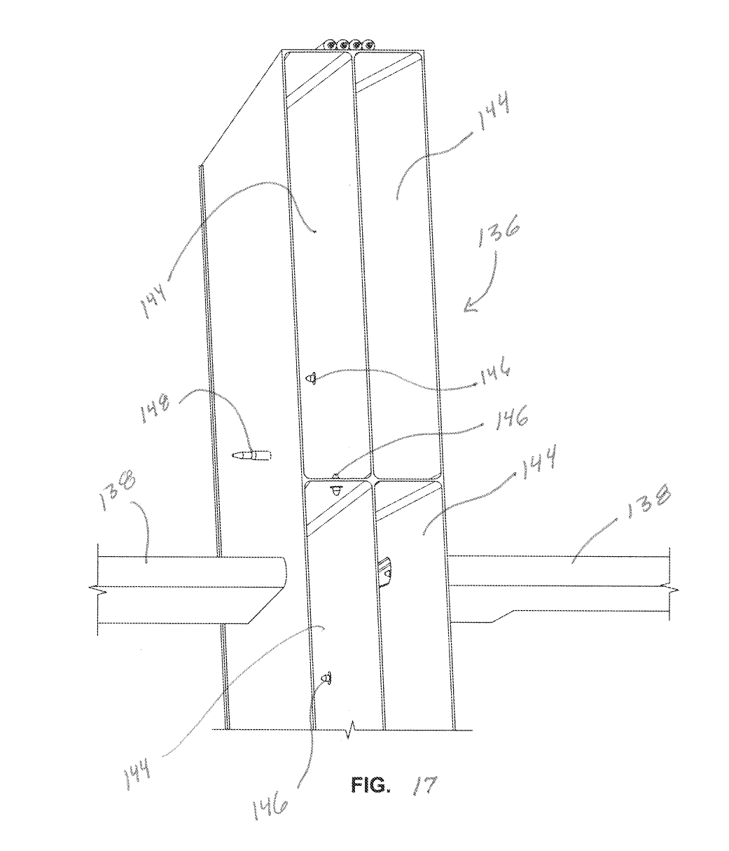

A portion of the electrical power generated by the turbine assembly 138 can be used to power peripherals in the lift system 126. FIG. 16 illustrates the lift system 12 and external actuators. The lift system 126 can be shaped like an airfoil oriented vertically. The external material used for the envelope 136 of the lift system 126 can be flexible, resilient, strong, and air tight. The shape of the lift system 126 can be designed to reduce drag on the lift system 126. The lift system 126 can be made lighter than air by filled the envelope 136 with gases that are lighter than air. For example, helium or hydrogen can be used. Horizontal stabilizers 138 can be attached to the envelope 136 and can be used for stability. In addition, ailerons 140 can be included. As arranged, the lift system 126 can facilitate translation and rotation of the lift system 126. Changes in altitude can be induced by releasing or adding lighter than air gas to the envelope. Gas can be released through bleed off control valves (shown as 148 in FIG. 17). In addition to being used to release gas, a bleed off control valves can also be used to impart a small force in the lateral direction, thus, moving the AWE system 126 in a lateral direction. The ailerons 140, attached to the horizontal stabilizers 138, can be used to impart both roll and pitch on the AWE system 126. Additionally, a rudder 142 can be included and be used to induce yaw on the AWE system 126.

FIG. 17 illustrates the internal structure of the envelope 136 and a pressure control system for the lighter-than-air lift AWE system 126. The envelope 136 can be divided into a number of internal chambers 144. To maintain equal pressure in each chamber 144, pressure control valves 146 can be used. The pressure control valves 146 provide for forcing pressure from one chamber 144 to the next. Each of the pressure control valves 146 can be operated independently. To remove lighter than air gas from the envelope 136, one or more bleed off valves 148 can be used. When using the bleed off valves 148, lighter than air gas is evacuated to the atmosphere. Lighter than air gas can also be removed from the envelope 136, recompressed, and stored in tanks to be reintroduced to the envelope 136 at a later time. By using combinations of the bleed off valves 148 and the pressure control valves 146, the lift force, and therefore the position of the AWE system 126 in the vertical direction, can be controlled and adjusted.

The control of the AWE system 126 can be achieved by generating forces and moments through use of the rudder 142, ailerons 140, bleed off valves 148, the tether 134, and removing or adding lighter than air gas to the envelope 136. The control surfaces and valves can be electrically connected to turbine assembly 128 and tether 134. Electric motors can power the control surfaces and electric servos can power the valves. The electricity used to power the motors and servos can be taken from the electricity generated by the turbine assembly 128. Alternatively the required electricity can be drawn through the tether 134. The combination of these control surfaces, the tether, and valves allows for the AWE systems 126 to translate and rotate in all directions.

If the ailerons 140 are rotated in opposite directions, the AWE system 126 will roll. If the ailerons 140 are moved in the same direction, the AWE system 126 will pitch. In another example, the horizontal stabilizers 138 are movable and essentially behave similar to ailerons 140. Moving the rudder 142 can allow the AWE system 126 to yaw. Adding or removing lighter than air gas from the envelope 136 will allow the AWE system 126 to change altitude. Furthermore, the tether 134 can be reeled in or out to change the altitude and position of the AWE system 126.

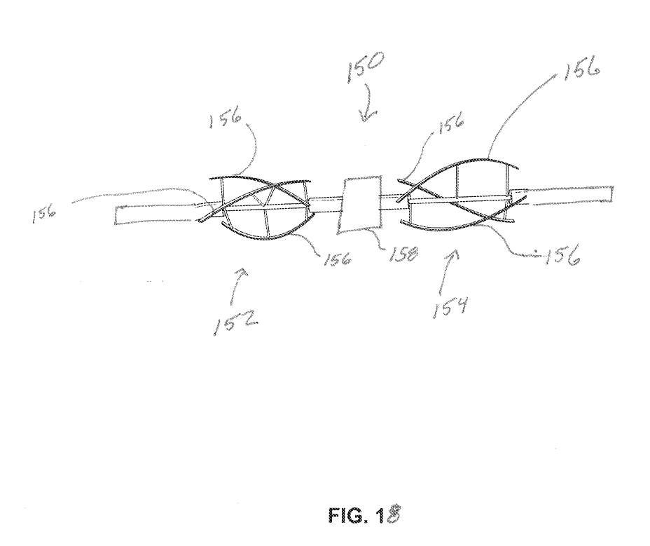

Although turbine assemblies have been described and illustrated herein as having blades shaped like airfoils, it will be understood that turbine assemblies can include other blade shapes and configurations. One example of alternative blades is illustrated in FIG. 18. A turbine assembly 150 includes two rotating assemblies 152, 154. Each rotating assembly 152, 154 has three helically shaped blades 156. The rotating assemblies 152, 154 are arranged to rotate in opposite directions and drive a generator 158 to generate electrical power. The helical shape of the blades 156 can result in a smooth rotational pattern as the turbine assembles 152, 154 as the blades move relative to the direction of the wind current.

As previously discussed, stabilization and control of an AWE system can be achieved by utilizing a control system. A control system can be implemented using an onboard computer program and mechanical controllers. The mechanical controllers can be driven by the onboard computer and have the ability to actuate ailerons, elevators, rudders, and wings; control the length of the tether; and control the adding and removing gas from the lighter-than-air lift system. The onboard computer can ensure that specifications programmed into the computer are met and allow for the repositioning of the wind turbine. Sensors onboard the AWE system, such as GPS or similar devices and uplinks to current weather, can allow for efficient positioning and orientation of AWE systems.

For examples described herein, the power output of the AWE systems can be proportional to the wind speed cubed. Higher wind speeds can provide for smaller wind capture device required to produce the same amount of energy as a ground-based system. In one example, if the wind speeds are twice as high at the deployment location of a AWE system as is the wind speed on the ground, a capture area of one eighth the size is needed to produce an equivalent electrical power output, because the power generated is equal to the wind velocity squared. Besides the smaller energy capture size needed due to the high wind speeds, the speed at which the turbine spins can be increased. Increasing the turbine speed will also increase the generator speed. A higher speed generator allows for the generator size to be decreased and lower the weight. The lower weight from the generator and smaller energy capture area lead to fewer infrastructures required.

The foregoing description of examples has been presented for purposes of illustration and description. It is not intended to be exhaustive or limiting to the forms described. Numerous modifications are possible in light of the above teachings. Some of those modifications have been discussed, and others will be understood by those skilled in the art. The examples were chosen and described in order to best illustrate principles of various examples as are suited to particular uses contemplated. The scope is, of course, not limited to the examples set forth herein, but can be employed in any number of applications and equivalent devices by those of ordinary skill in the art.

What is claimed is:

1. An airborne wind energy system comprising:
a lift system including a substantially airtight chamber for storing lighter-than-air gases;
a wind power generating system coupled to the lift system, the wind power generating system including at least a first rotating assembly;
a tether coupled to the wind power generating system; and
a control system.

2. The airborne wind energy system of claim 1, where the wind power generation system further includes:
a second rotating assembly arranged to rotate in a direction opposite of the first rotating assembly; and
a third rotating assembly arranged to rotate in a the same direction as the first rotating assembly.

3. The airborne wind energy system of claim 2, where the net angular momentum of the first rotating assembly, the second rotating assembly, and third rotating assembly is substantially zero when the first rotating assembly, the second rotating assembly, and third rotating assembly are rotating and the respective magnitude of the angular velocities are substantially the same.

4. The airborne wind energy system of claim 3, where the wind power generating system further includes a generator coupled to the first rotating assembly, the second rotating assembly, and the third rotating assembly.

5. The airborne wind energy system of claim 4, where the generator generates electrical power when the first rotating assembly, the second rotating assembly, and third rotating assembly are rotating.

6. The airborne wind energy system of claim 3, where each of the first rotating assembly, the second rotating assembly, and third rotating assembly include at least one airfoil.

7. The airborne wind energy system of claim 6, where the at least one airfoil of each of the first rotating assembly, the second rotating assembly, and third rotating assembly is adjustable by the control system.

8. The airborne wind energy system of claim 1, where the lift system is an airship.

9. The airborne wind energy system of claim 8, where the airship comprises:
a body for housing the substantially airtight chamber;
a first wing attached to the body;
a second wing attached to the body; and
a tail section attached to the body.

10. The airborne wind energy system of claim 9, where the first wing includes a first aileron and the second wing includes a second aileron, and the first aileron and second aileron are adjustable by the control system.

11. The airborne wind energy system of claim 10, where the control system adjusts the first aileron and second aileron so that the airship maintains a static position.

12. The airborne wind energy system of claim 9, where the tail section includes a first elevator and a second elevator, and the first elevator and second elevator are adjustable by the control system.

13. The airborne wind energy system of claim 12, where the control system adjusts the first elevator and second elevator so that the airship maintains a static position.

14. The airborne wind energy system of claim 9, where the tail section includes a rudder, and the rudder adjustable by the control system.

15. The airborne wind energy system of claim 14, where the control system adjusts the rudder so that the airship maintains a static position.
